(19) United States
(12) Patent Application Publication
(10) Pub. No.: US 2025/0370664 A1
(43) Pub. Date: Dec. 4, 2025

(54) PRINTING APPARATUS, METHOD FOR CONTROLLING PRINTING APPARATUS, AND STORAGE MEDIUM

(71) Applicant: CANON KABUSHIKI KAISHA, Tokyo (JP)

(72) Inventors: Yuki Igarashi, Tokyo (JP); Satoshi Kitai, Kanagawa (JP); Yusuke Kiyokawa, Tokyo (JP)

(21) Appl. No.: 19/180,683

(22) Filed: Apr. 16, 2025

(30) Foreign Application Priority Data
May 30, 2024 (JP) 2024-087941

(51) Int. Cl. G06F 3/12; B41J 11/00; B41J 11/48

(52) U.S. Cl. CPC G06F 3/1204; B41J 11/009; B41J 11/485; G06F 3/1229; G06F 3/1273; B41J 2203/01

(57) ABSTRACT

A printing apparatus includes: an obtainment unit obtaining a characteristic value of a sheet in a feeder; an extraction unit extracting candidates to be a print parameter for the sheet from a group of sheet type candidates stored in a storage by comparing the obtained characteristic value and characteristic values of the candidate group; a display control unit displaying, on a display, a setting screen including the extracted candidates; and a determination unit determining the print parameter based on the extracted candidates and information indicating a history of sheet types used. If the history information includes none of the extracted candidates, a determination unit determines that a candidate selected by a user on the setting screen is the print parameter. If the history information includes any of the extracted candidates, the determination unit automatically determines the print parameter even if the user selects no candidate on the setting screen.

### BACKGROUND

### Field

The present disclosure relates to settings on a print medium used for printing.

### Description of the Related Art

In order for a printing apparatus to print high-quality images, it is known to use control parameters suitable for the type of sheet (printing medium). Japanese Patent Laid-Open No. 2020-121533 (hereinafter referred to as Literature 1) discloses a printing apparatus with two modes used to print images using suitable control parameters: a mode where a print medium type selected by a user from print medium type candidates ranked based on predetermined criteria is determined as a print target and an automatic determination mode where the most highly ranked print medium type is determined as a print target unless a print medium type is selected by a user within a predetermined period of time.

### SUMMARY

In the automatic determination mode in Literature 1, a print medium type might be automatically determined regardless of the likelihoods of the candidates displayed. As a result, a print medium type unintended by the user may be used, which could end up impairing user convenience. Also, because print medium type candidates are determined from all the print medium types, the print medium type candidates may include one that is not suitable for the user.

A printing apparatus according to an aspect of the present disclosure includes: an obtainment unit that obtains a characteristic value of a sheet inserted into a sheet feeder; an extraction unit that extracts at least one candidate to use as a print setting for the inserted sheet from a first group of candidates of a sheet type stored in a storage unit based on results of comparison between the obtained characteristic value and each of characteristic values of the first group of candidates; a display control unit that displays, on a display unit, a print setting screen including the extracted at least one candidate; and a determination unit that determines a print parameter for the inserted sheet based on the extracted at least one candidate and history information indicating a history of sheet types used. In a case where the history information does not include a sheet type corresponding to the at least one candidate extracted from the first group of candidates, the determination unit determines that a candidate selected by user operation on a first print setting screen is the print parameter to use for printing, the first print setting screen being displayed on the display unit by the display control unit after the extraction unit extracts the at least one candidate. In a case where the history information includes the sheet type corresponding to the at least one candidate extracted from the first group of candidates, the determination unit automatically determines the print parameter for the inserted sheet even if a candidate is not selected by user operation on a second print setting screen displayed on the display unit by the display control unit after the extraction unit extracts the at least one candidate.

Further features of the present invention will become apparent from the following description of exemplary embodiments with reference to the attached drawings.

### BRIEF DESCRIPTION OF THE DRAWINGS

FIGS. 1A and 1B are perspective views showing the configuration of a printing apparatus;

FIG. 2 is a diagram showing the configuration of a carriage;

FIG. 3 is a diagram showing the configuration of an optical sensor;

FIG. 4 is a diagram showing the block configuration of a control system of the printing apparatus;

FIGS. 5A to 5E are each a table showing a group of print medium type candidates and information thereon;

FIGS. 6A to 6J are diagrams showing what an input/output unit displays for switching of a print medium type selection mode;

FIG. 7 is a flowchart showing the flow of print medium type determination;

FIG. 8 is a flowchart showing the flow of extraction of print medium type candidates;

FIGS. 9A to 9C are flowcharts showing what is displayed on the input/output unit;

FIGS. 10A to 10P are diagrams showing what is displayed on the input/output unit; and

FIG. 11 is a flowchart showing the flow of print medium type determination.

### DESCRIPTION OF THE EMBODIMENTS

### Embodiment 1

### (Overall Configuration)

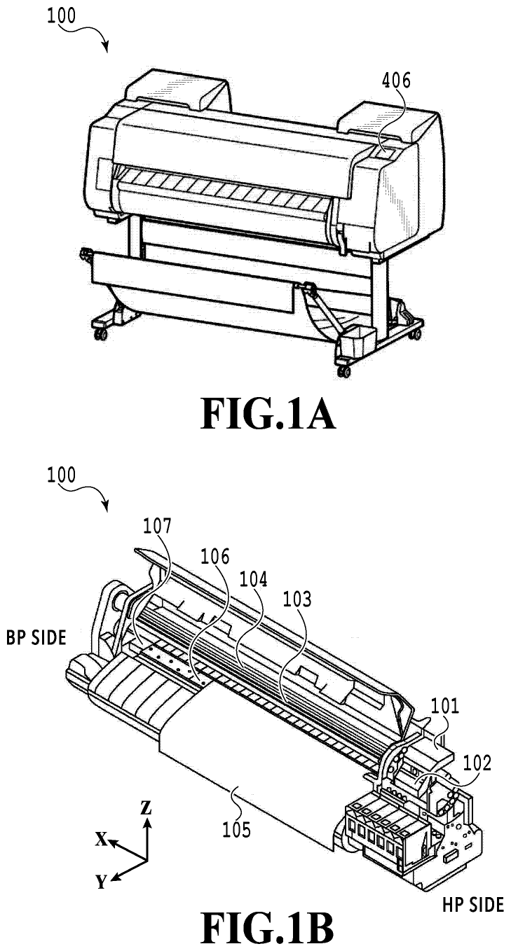

FIGS. 1A and 1B are perspective views showing the configuration of a printing apparatus 100. FIG. 1A shows the overall appearance of the printing apparatus 100, and FIG. 1B shows the internal structure of the printing apparatus 100 with its upper cover opened, omitting the outer casing. The printing apparatus 100 of the present embodiment is an inkjet printing apparatus employing the inkjet printing method and performs printing by ejecting ink droplets as a print material onto a printing medium. The printing apparatus 100 includes what is called a serial-type printhead and performs printing by moving a carriage 101 having a printhead 102 mounted thereon in a reciprocating manner in an X-direction, while conveying a print medium in a Y-direction as a conveyance direction, the X-direction and the Y-direction intersecting with each other. Alternatively, the printing apparatus may be an inkjet printing apparatus including what is called a line-type printhead with nozzle arrays formed as wide as the print width relative to the direction in which a print medium is conveyed. Also, the printing apparatus may be a multifunction peripheral (MFP) integrally having not only a print function, but also other functions such as a scan function, a facsimile function, and a send function. In the present embodiment, the printing apparatus 100 is equipped with functions of an information processing apparatus for performing print medium type determination processing to be described later for determining the print medium type to use.

The printing apparatus 100 has an input/output unit 406 at its upper portion. The input/output unit 406 is an operation panel with a display unit and can display ink levels and sheet (print medium) type candidates on a display, and a user can select a print medium type or configure print settings by operating keys.

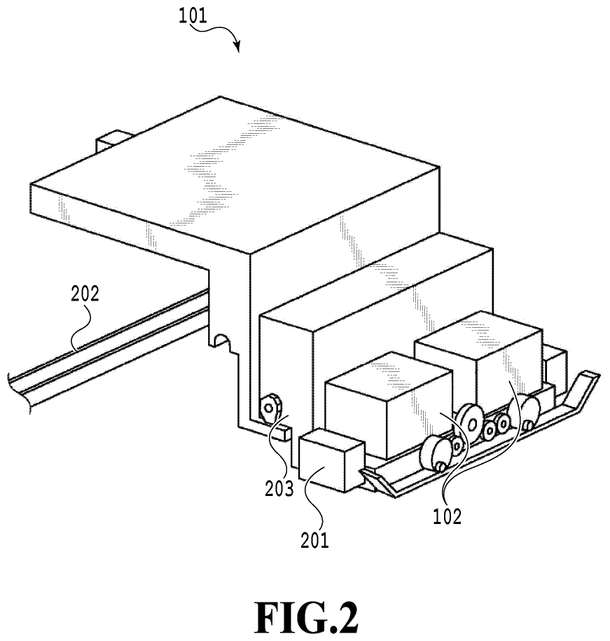

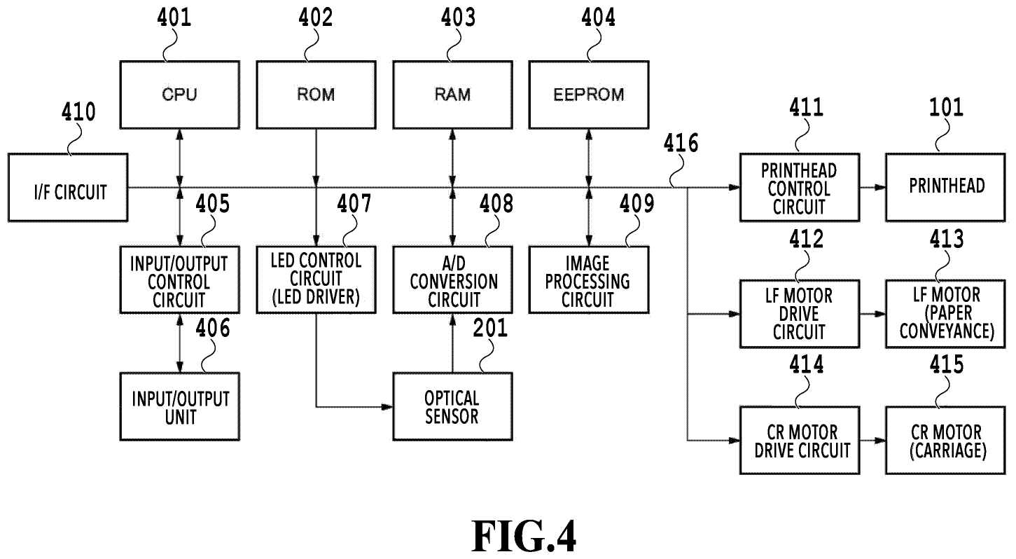

The carriage 101 has an optical sensor 201 (FIG. 2) and the printhead 102 which has an ejection port surface formed thereon, the ejection port surface being provided with ink-ejecting ejection ports. The carriage 101 is configured to be able to reciprocate in the X-direction (the carriage moving direction) along a shaft 104 via a conveyance belt 103, as driven by a carriage motor 415 (FIG. 4). In the present embodiment, using the optical sensor 201, the printing apparatus 100 can obtain an irregular reflection characteristic value and a regular reflection characteristic value on the surface of a print medium 105 or measure the distance between the carriage 101 and the print medium 105.

The print medium 105, such as rolled paper, is conveyed by a conveyance roller (not shown) in the Y-direction on a platen 106. Printing is performed by ejecting ink droplets from the printhead 102 while moving the carriage 101 in the X-direction above the print medium 105 conveyed to the platen 106 by the conveyance roller. Once the carriage 101 moves to the end of a print region on the print medium 105, the conveyance roller conveys the print medium 105 for a certain distance to move a region to be scanned and printed next to a position printable by the printhead 102. An image is printed by the above operations performed repeatedly.

### (Configuration of the Carriage)

FIG. 2 is a diagram showing the configuration of the carriage 101. The carriage 101 is configured including a translator 202 and a head holder 203. The head holder 203 includes the printhead 102 and the optical sensor 201 which is a reflective sensor. As shown in FIG. 2, the optical sensor 201 is configured such that its bottom surface is at the same level or higher than the bottom surface of the printhead 102.

### (Configuration of the Optical Sensor)

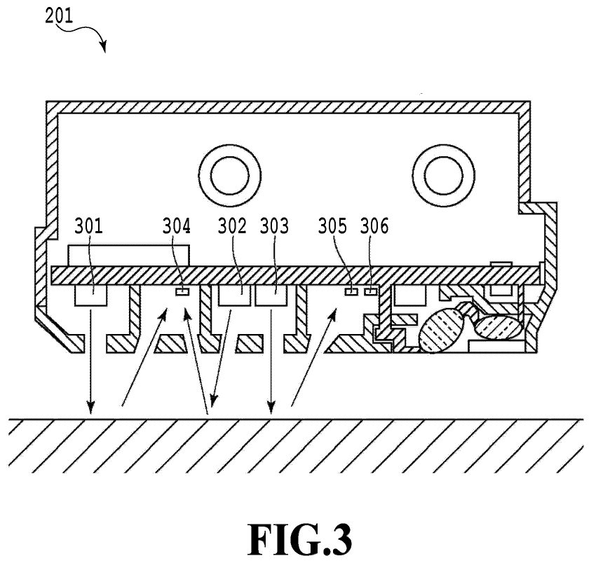

FIG. 3 is a schematic sectional view showing the configuration of the optical sensor 201. The optical sensor 201 includes, as optical elements, a first LED 301, a second LED 302, a third LED 303, a first photodiode 304, a second photodiode 305, and a third photodiode 306. The first LED 301 is a light source whose angle of radiation is normal (90°) to the surface (measurement surface) of the print medium 105. The first photodiode 304 receives light applied from the first LED 301 and then reflected by the print medium 105, at an angle of 45° about the Z-direction. In other words, the first photodiode 304 forms an optical system that detects what is called an irregular reflection component of the light reflected by the print medium 105.

The second LED 302 is a light source whose angle of radiation is 60° about the Z-direction relative to the surface (measurement surface) of the print medium 105. The first photodiode 304 receives light applied from the second LED 302 and then reflected by the print medium 105, at an angle of 60° about the Z-direction. In other words, the angle of light emission and the angle of light reception are equal, which means that the first photodiode 304 forms an optical system that detects what is called a regular reflection component of the light reflected by the print medium 105.

The third LED 303 is a light source whose angle of radiation is normal (90°) to the surface (measurement surface) of the print medium 105. The second photodiode 305 and the third photodiode 306 receive light applied by the third LED 303 and then reflected by the print medium 105. The amounts of light received by the second photodiode 305 and the third photodiode 306 change depending on the distance between the optical sensor 201 and the print medium 105, and the optical sensor 201 operates as a distance measuring sensor that measures the distance between the optical sensor 201 and the print medium 105. Because the distance between the optical sensor 201 and the platen 106 is predefined, the “paper thickness” of the print medium 105 is obtained based on the measured distance between the optical sensor 201 and the print medium 105.

Although the optical sensor 201 is mounted at the carriage in the present embodiment, a different mode may be employed. For example, the optical sensor 201 may be mounted at the printing apparatus in a fixed manner, or a measurement device separate from the printing apparatus may measure characteristic values of a print medium such as irregular reflection and regular reflection and send the measured characteristic values to the printing apparatus.

### (Block Diagram)

FIG. 4 is a diagram showing the block configuration of a control system of the printing apparatus 100. A ROM 402 is non-volatile memory and stores, for example, control programs for controlling the printing apparatus 100 or programs for implementing operations of the present embodiment. The operations of the present embodiment are implemented by, for example, a CPU 401 loading a program stored in the ROM 402 into a RAM 403 and executing the program. The RAM 403 is used as working memory by the CPU 401. An EEPROM 404 as a storage unit stores data to be retained even after the printing apparatus 100 is powered off. At least the CPU 401 and the ROM 402 implement the functions of the information processing apparatus for performing the print medium determination processing to be described later. In the present embodiment, the EEPROM 404 stores a history of print media fed and used so far. This stored information is handled as usage history information. The EEPROM 404 also stores a group of predetermined print medium type candidates, characteristic values of the print medium types, extraction ranges for the characteristic values of the print medium types, and categories of the print medium types. The categories are groups into which print medium types are broadly classified. In the present embodiment, four categories are set: plain paper, coated paper, gloss paper, and film sheet. For instance, a print medium type is classified into the “plain paper” category in a case where the print medium type is Premium Plain Paper and into the “gloss paper” category in a case where the print medium type is Unique Gloss Paper. Although print media include non-paper media, a term “paper” is used in notifications to the user in the present embodiment. The print media usage history information and the characteristic values of the print medium types may be stored not in a storage medium inside the printing apparatus, but in a host computer, a server, or the like.

An interface (I/F) circuit 410 connects the printing apparatus 100 to an external network such as a LAN. Through the I/F circuit 410, the printing apparatus 100 transmits and receives various jobs, data, and the like to and from an external apparatus such as a host computer.

The input/output unit 406 includes an input unit and an output unit. The input unit receives, from a user, an instruction for power-on, an instruction for print execution, or an instruction for configuring settings of various functions. The output unit displays various kinds of apparatus information, such as power-saving mode, or screens for configuring settings of various functions that the printing apparatus 100 can execute. In the present embodiment, the input/output unit 406 is an operation panel provided to the printing apparatus 100, and the input/output unit 406 is connected so that data can be transmitted to and received from a system bus 416 via an input/output control circuit 405. In the present embodiment, the CPU 401 controls displaying of information by the output unit.

The input unit may alternatively be a keyboard on the external host computer, and the printing apparatus may be able to receive user instructions from the external host computer. The output unit may be an LED display, an LCD display, or a display connected to the host apparatus. Also, in a case where the input/output unit is a touch panel, user instructions can be received via software keys. Also, the input/output unit 406 may be a speaker and a microphone, so that a user input may be audio input and a user notification may be audio output.

Note that in the present embodiment, an information processing apparatus including a CPU and a ROM with similar functions to the CPU 401 and the ROM 402 and externally connected to the printing apparatus 100 may perform the print medium type determination processing to be described later and determine a print medium type used in the printing apparatus 100.

To perform measurement using the optical sensor 201, the CPU 401 drives an LED control circuit 407 to perform control to light predetermined LEDs in the optical sensor 201. Each photodiode in the optical sensor 201 outputs a signal in accordance with the light that it receives. The signal is converted into a digital signal by an A/D conversion circuit 408 and is temporarily saved in the RAM 403. Data to be saved even after the printing apparatus 100 is powered off is stored in the EEPROM 404.

A printhead control circuit 411 controls print operations by the printhead 102, such as a nozzle driving order, by supplying driving signals in accordance with print data to a nozzle driving circuit mounted in the printhead 102 and including selectors or switches. For example, in the event where data to be printed is transmitted from the outside to the I/F circuit 410, the data to be printed is temporarily saved in the RAM 403. Then, the printhead control circuit 411 drives the printhead 102 based on print data converted from the data to be printed to be used for printing. In this event, a line-feed (LF) motor drive circuit 412 conveys a print medium by driving an LF motor 413 based on, e.g., the band width in the print data and thereby rotating the conveyance roller connected to the LF motor 413. A carriage (CR) motor drive circuit 414 drives a carriage (CR) motor 415 and thereby scans the carriage 101 via the conveyance belt 103.

Data sent from the I/F circuit 410 includes not only data to be printed, but also data indicating settings configured by the printer driver. Also, data to be printed may be, for example, received from the outside via the I/F circuit 410 and stored in a storage unit or may be stored in advance in a storage unit such as a hard disk. The CPU 401 reads image data from a storage unit and converts it into print data to be used by the printhead 102 (binarization processing) by controlling an image processing circuit 409. The image processing circuit 409 executes various kinds of image processing such as, in addition to the binarization processing, color space conversion, HV conversion, gamma correction, and image rotation.

### (Group of Print Medium Type Candidates)

In the present embodiment, as described earlier, the EEPROM 404 stores the following pre-defined information: a group of print medium type candidates, characteristic values of the print medium types, the extraction ranges for the characteristic values of the print medium types, the categories of the print medium types, usage history information on the print medium types.

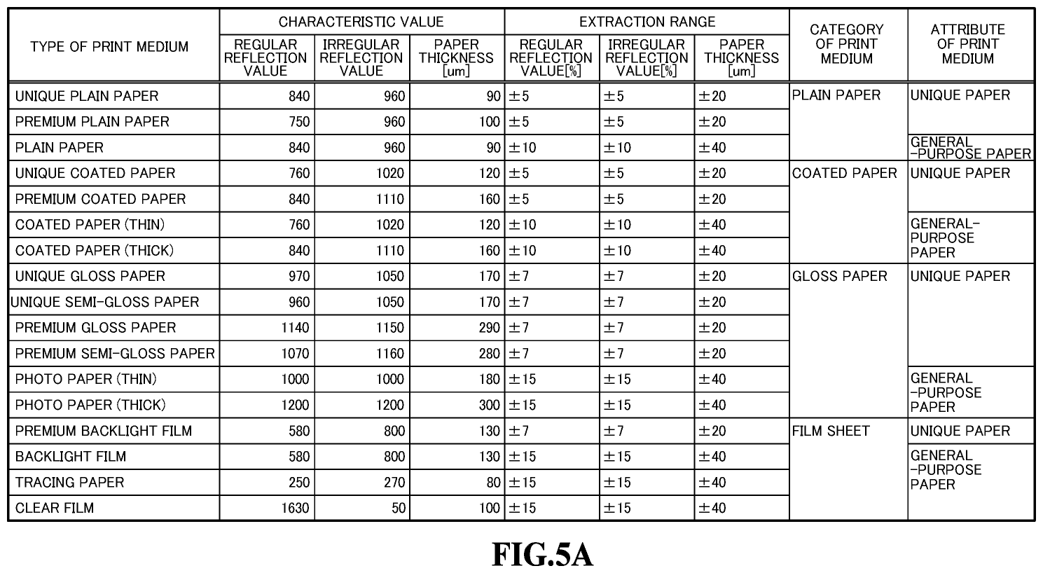

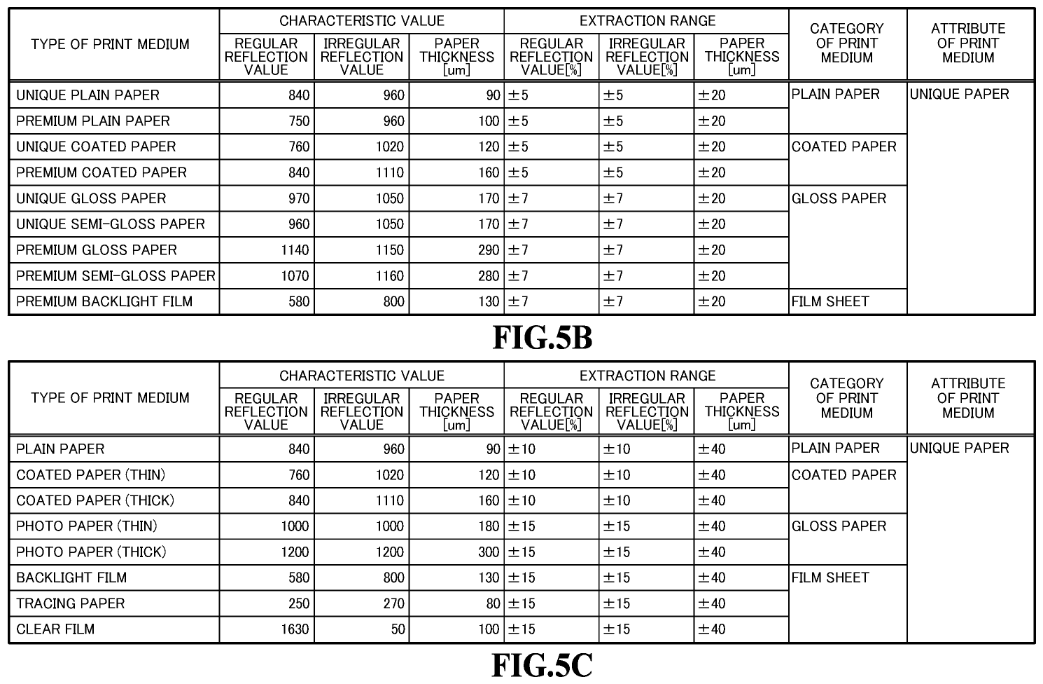

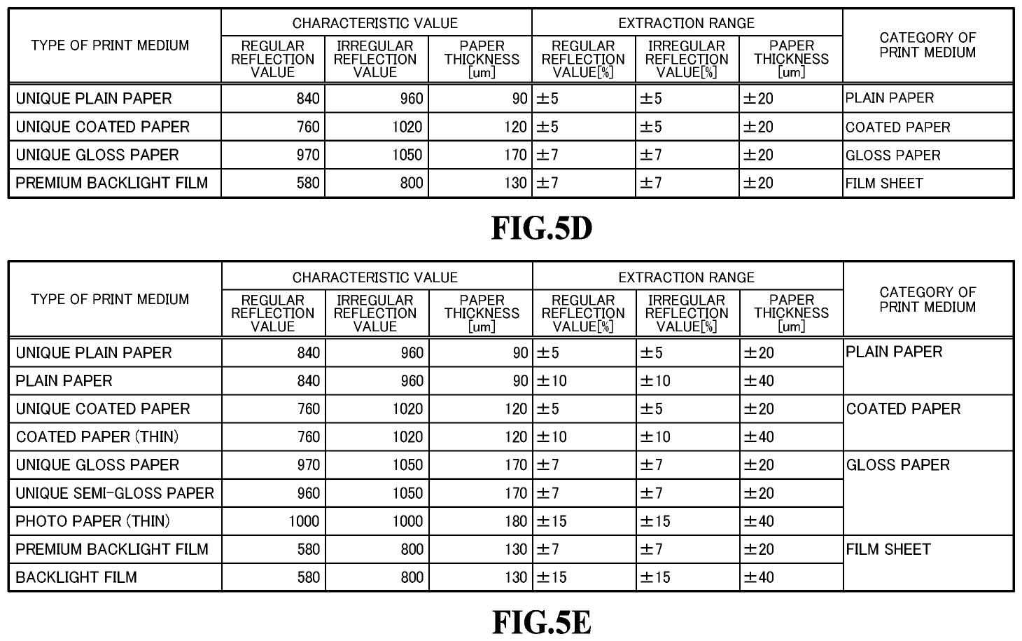

FIG. 5A shows a group of candidates that can be applied to sheet settings in the present embodiment. Print medium types are broadly classified into the four categories: gloss paper, plain paper, coated paper, and film sheet. Also, aside from being classified into one of those print medium categories, a print medium type falls roughly into unique paper or general-purpose paper. Unique paper is a sheet the product name of which is stored in the printing apparatus 100 in advance. For instance, “Premium Gloss Paper,” which is one of the print medium types in FIG. 5A, is written in its product name. For this reason, the attribute of this print medium type is “unique paper,” and the category of this print medium type is “gloss paper.” In another instance, “Coated Paper (Thin)” is not a product name, but a generally-used name. For this reason, the attribute of this print medium type is “general-purpose paper,” and the category of this print medium type is “gloss paper.” Each print medium type is classified into one of the four “categories” as shown in FIG. 5A. Also, in addition to the categories, each print medium type is classified into one of the “attributes”: unique paper or general-purpose paper.

The reason for roughly classifying a sheet into unique paper or general-purpose paper is because the printing apparatus 100 has dedicated sheet settings to apply for unique paper to allow optimal use of the unique paper. Also, some users know a print medium type by its product name. In order for such users to know the print medium types, the print settings screen and the like displayed for the paper settings of the printing apparatus 100 use product names (unique paper) or generally-used names (general-purpose paper).

The candidate group table shown in FIG. 5A is a table stating all the print medium types and stored in the EEPROM 404. Also, FIGS. 5B to 5D are each a diagram showing a group of print medium type candidates selected from FIG. 5A based on a particular condition.

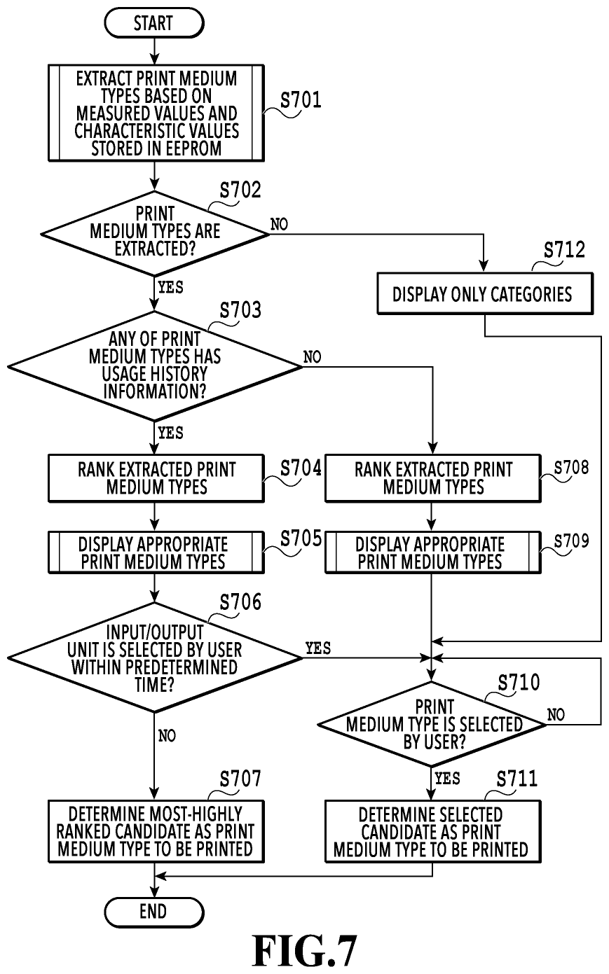

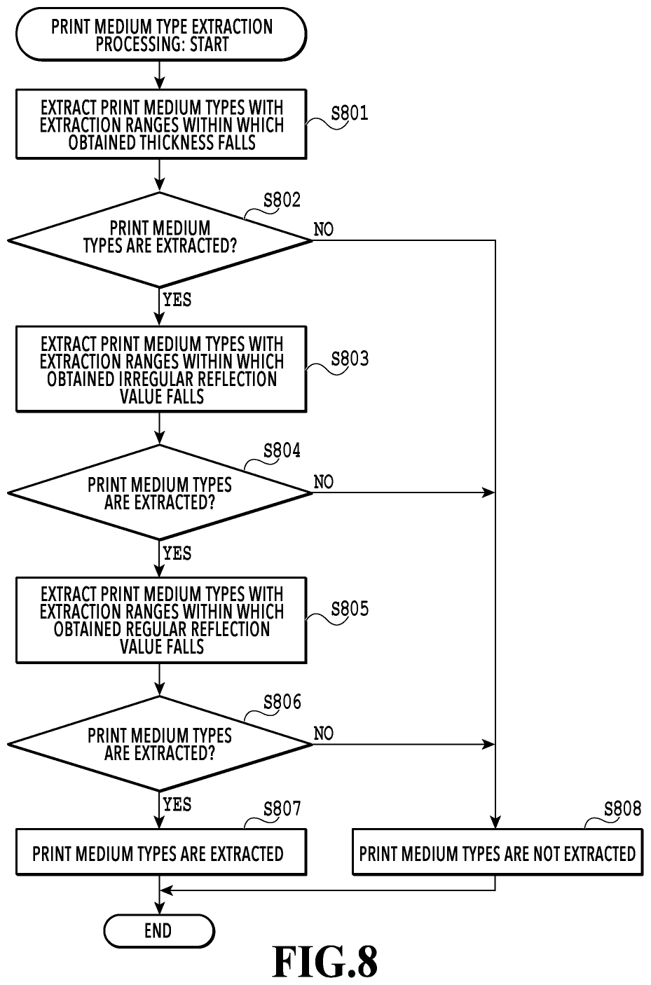

The following characteristic values are set for each print medium type: a regular reflection value, an irregular reflection value, and a paper thickness. The irregular reflection value and the regular reflection value are each a value obtained by A/D conversion of an output voltage outputted by the optical sensor 201 upon light reception into 11 bits. An extraction range is set for each characteristic value, and print medium type candidates that fall within the extraction range are extracted in the flow of print medium type determination. How to extract print medium type candidates based on each of the characteristic values will be described later using FIGS. 7 and 8. For instance, for Unique Plain Paper, the regular reflection value is set to 840, and the extraction range is set to ±5%. Being ±5% of 840, the extraction range is from 798 to 882. Because the paper thickness is set to 90 um with its extraction range being ±20 um, the extraction range is from 70 um to 110 um.

### (Switching Print Medium Type Selection Mode)

In the present embodiment, there are four modes for selecting a print medium type on the print settings screen: Fixed Mode, Manual Mode, Estimation-Based Manual Mode, and Estimation-Based Auto Mode. These modes are for determining a print setting to apply in printing of a print medium. Among these modes, Estimation-Based Manual Mode and Estimation-Based Auto Mode are measurement-based modes where a print medium type is estimated based on measurement results. The measurement results are results of measurement of characteristic values of a print medium obtained by the optical sensor 201 after a user sets the print medium at the sheet feeder. Meanwhile, Manual Mode and Fixed Mode are specification-based modes not using measurement results, where a print medium type is specified by a user or determined based on the mode specified. Each of the modes is described below.

In Fixed Mode, a print medium type set by a user in advance is automatically determined as a print target.

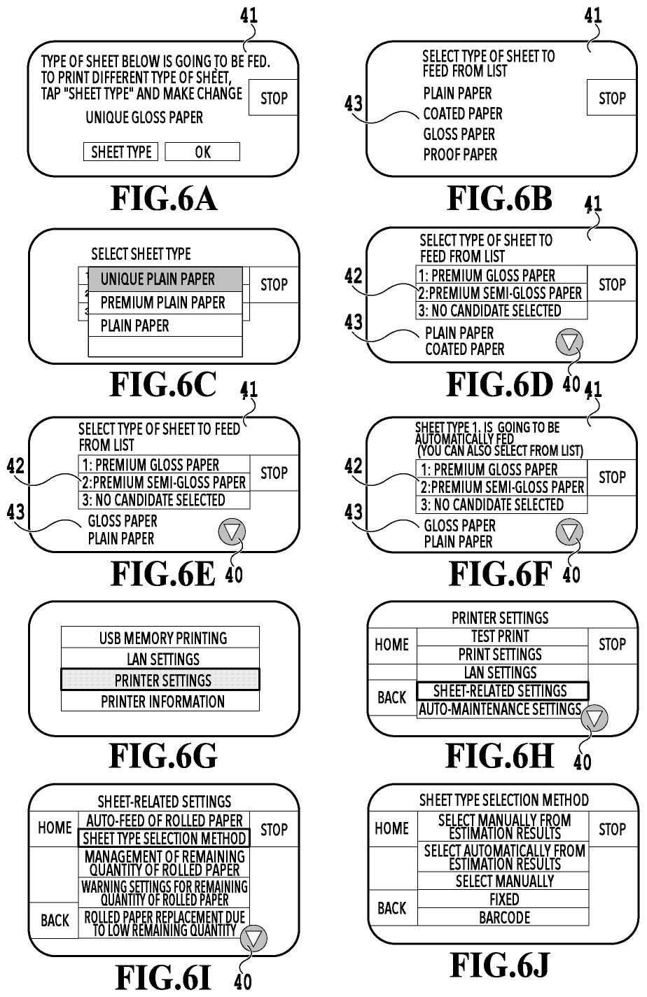

FIGS. 6A to 6J show print settings screens displayed on the input/output unit 406 of the printing apparatus 100 to determine a sheet (a print medium) to be used for printing. The printing apparatus 100 executes printing using the print setting determined on this settings screen.

The flow of printing by the printing apparatus 100 is described. A user inserts a sheet to use for printing into the sheet feeder of the printing apparatus 100. This causes a sheet feed operation to start. In this event, as part of the sheet feed operation, characteristic values of the sheet are obtained using the optical sensor 201 as described using FIG. 3. Then, based on the characteristic values thus obtained, a print settings screen including sheet (print medium) type candidates is displayed on the input/output unit 406. Once a sheet type is selected by user operation or automatically, the printing apparatus 100 completes the rest of the sheet feed operation, such as detection of the sheet's leading edge. This establishes a state where the sheet is fed to the printing apparatus 100. After that, the printing apparatus 100 starts printing based on printing parameters for the selected sheet type. Thus, the settings screens in FIGS. 6A to 6J are displayed on the input/output unit 406 in the process between the start and completion of the sheet feed operation.

FIG. 6A is a print settings screen in Fixed Mode. As shown in FIG. 6A, “Sheet of type below is going to be fed. To print a sheet of different type, tap “Sheet Type” and make change.” is displayed in a message field 41 on the input/output unit 406, and a preset print medium type is displayed in a field under the message field 41. In a case where the user does not operate the input/output unit 406 within a predetermined period of time or selects “OK” in FIG. 6A, the print medium type preset by the user, for instance, “Unique Gloss Paper,” is determined as a print medium to be printed. In a case where the user selects “Sheet Type” in FIG. 6A within the predetermined period of time, “Select type of sheet to feed from list” is displayed in the message field 41 with a category display field 43 displaying print medium type categories, as shown in FIG. 6B. The user can select one of the print medium type categories. Once the user selects a category, the user can select a print medium type from the ones belonging to the category as shown in FIG. 6C, and once the user selects a print medium type, the print medium type can be determined as a print target.

In Manual Mode, as shown in FIG. 6D, “Select type of sheet to feed from list” is displayed in the message field 41 on the input/output unit 406 with a candidate display field 42 chronologically displaying a history of print medium types selected so far and the category display field 43 displaying categories in a predetermined order. By touching a button 40, the user can scroll down the screen. The user can determine a print medium type to be printed from the history or the categories. Note that the reason why the third row from the top in the candidate display field 42 says “No candidate selected” is because FIG. 6D shows an example where only two print medium types have been set before.

In Estimation-Based Manual Mode, the optical sensor 201 is used to measure the characteristics of the print medium 105 to be printed, and print medium type candidates are displayed on the input/output unit 406 based on results of the measurement. Specifically, as shown in FIG. 6E, “Select type of sheet to feed from list” is displayed in the message field 41, and candidates based on the measurement results on the characteristics are displayed in the candidate display field 42. Also, the categories in the category display field 43 are displayed in an order based on the measurement results. By selecting a print medium type on the input/output unit 406, the user determines the print medium type to be printed.

In Estimation-Based Auto Mode, the optical sensor 201 is used to measure the characteristics of the print medium 105 to be printed, and print medium type candidates are displayed on the input/output unit 406 based on results of the measurement. A print medium type is then determined automatically. Specifically, as shown in FIG. 6F, “Sheet Type 1. is going to be automatically fed (you can also select from list)” is displayed in the message field 41, with the candidate display field 42 displaying candidates based on the characteristic measurement results. Also, the categories in the category display field 43 are displayed in an order based on the measurement results. In a case where there is no user operation within a predetermined period of time, the candidate displayed with the highest rank is determined automatically as a print medium type to be printed. In a case where the user selects a print medium type, the selected print medium type is determined as the type of the print medium to be printed.

A user can switch between these four modes. FIG. 6G shows a home screen displayed on the input/output unit 406. Note that FIG. 6G shows how the screen looks after “Printer Settings” is selected from among items displayed on the home screen. Once an item is selected, the selected item is highlighted, and the next screen is displayed. In FIG. 6G in the present embodiment, the selected item is highlighted by having a background color different from the other items and being surrounded by a thicker frame.

Once “Printer Settings” is selected on the home screen, a printer settings screen like the one shown in FIG. 6H is displayed. By touching the button 40 displayed in FIG. 6H, the user can scroll down the screen. Once “Back” is touched, the screen switches from the screen in FIG. 6H back to the home screen in FIG. 6G. Once “Sheet-Related Settings” is selected on the printer settings screen, the “Sheet-Related Settings” item is highlighted as shown in FIG. 6H. Then, a sheet-related settings screen like the one shown in FIG. 6I is displayed. Note that FIG. 6I shows how the settings screen looks after “Sheet Type Selection Method” is selected on the settings screen. The sheet-related settings screen displays items for setting print medium information set in the printing apparatus 100, such as an item for setting the height of the printhead 102 during printing and an item for setting the cut speed of cutting rolled paper. Once “Sheet Type Selection Method” is selected on the sheet-related settings screen in FIG. 6I, a screen for setting the sheet type selection method like the one shown in FIG. 6J is displayed. On this screen, the user can set any of the above-described modes to use to select a print medium type. Estimation-Based Auto Mode is executed once “Select automatically from estimation results” displayed in FIG. 6J is selected, and Estimation-Based Manual Mode is executed once “Select manually from estimation results” displayed in FIG. 6J is selected.

In Estimation-Based Auto Mode in the present embodiment, basically, in a case where there is no user operation after candidates are displayed, the print medium type displayed highest among the candidates is applied to the print settings. In addition, in the present embodiment, in a case where the group of candidates extracted to display candidates do not include any print medium type with usage history information, candidates are displayed based on predetermined criteria, and then a print medium type is determined by the user's select operation. In other words, a print medium type is not determined automatically until the user performs a select operation. Thus, even in a case where the print medium type candidates displayed include only ones that the user has never used before, there is time for the user to check the candidates. This is to help prevent mistakes from being made in configuration of print settings. Flowcharts for configuring print settings of the present embodiment are described below.

### (Flowchart for Print Medium Type Determination)

FIG. 7 is a flowchart of processing for determining a print medium type to use in printing of the present embodiment in the present embodiment. The print medium type determination processing is processing performed with the print medium type selection mode having been set by a user in advance. Note that the present embodiment is described assuming that Estimation-Based Auto Mode has been set in advance among the four modes described above.

The processing of the present flowchart is executed by the CPU 401 of the printing apparatus 100 by loading a program stored in the ROM 402 into the RAM 403. Also, the processing of the present flowchart starts once a user inserts a print medium into the sheet feeder.

In S701, based on results of comparison between measurement values of the print medium inserted into the sheet feeder and the characteristics values stored in the EEPROM 404, the CPU 401 extracts candidates of the print medium type to use for the print settings. This print medium type candidate extraction processing (details of S701) will be described later.

In S702, the CPU 401 determines whether any print medium type has been extracted in S701. If it is determined that print medium types have been extracted, the CPU 401 proceeds to S703. If no print medium type has been extracted, the CPU 401 proceeds to S712.

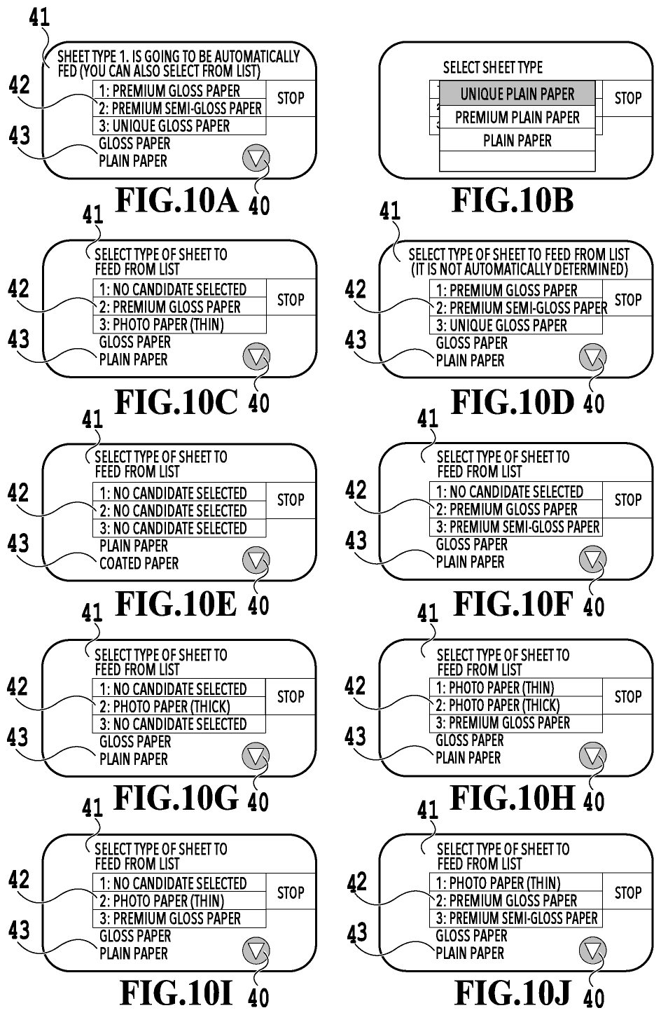

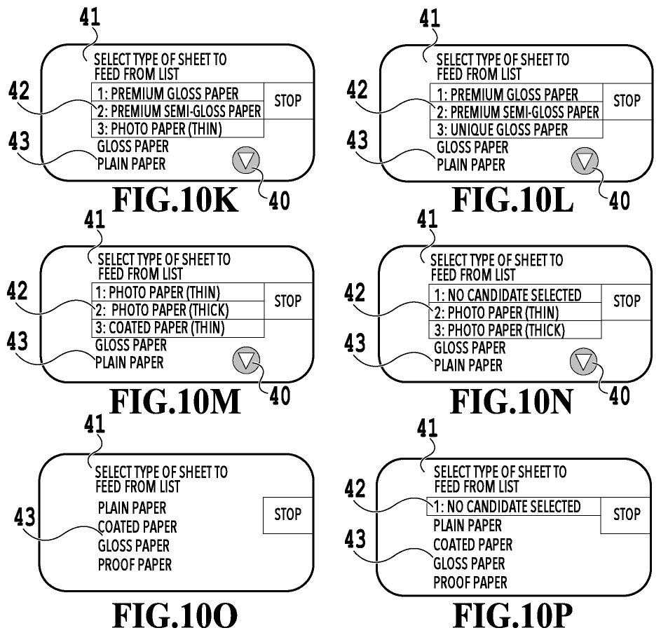

If it is determined in S702 that no print medium type has been extracted, in S712 the CPU 401 displays only categories on the input/output unit 406. An example of how only categories are displayed will be described using FIG. 10.

In S703, the CPU 401 determines whether any of the print medium type candidates extracted in S701 has usage history information. Usage history information is information indicating that the target print medium type has been applied to the print settings for the printing apparatus 100 in the past. If it is determined that there is a print medium type with usage history information, the CPU 401 proceeds to S704. If it is determined that there is no print medium type with usage history information, the CPU 401 proceeds to S708.

In S704, based on predetermined criteria, the CPU 401 determines the order of priority of the print medium types with usage history information among the print medium types extracted in S701. The order of priority of the print medium type candidates are determined as follows. Specifically, the rank of each print medium type is determined so that the closer its characteristic values stored in the EEPROM 404 are to the measurement values obtained, the higher the rank. The present embodiment determines the order of priority so that, as expressed in Formula (1) below, a print medium type with a smaller absolute value of the sum of squares of differences between characteristic values and corresponding measured values is ranked higher.

|(Measured value of regular reflection value−regular reflection value)²+(measured value of irregular reflection value−irregular reflection value)²+(measured value of paper thickness−paper thickness)²| Formula (1)

The characteristic values may be weighted by being multiplied with predetermined coefficients, or only values of particular characteristic values may be used.

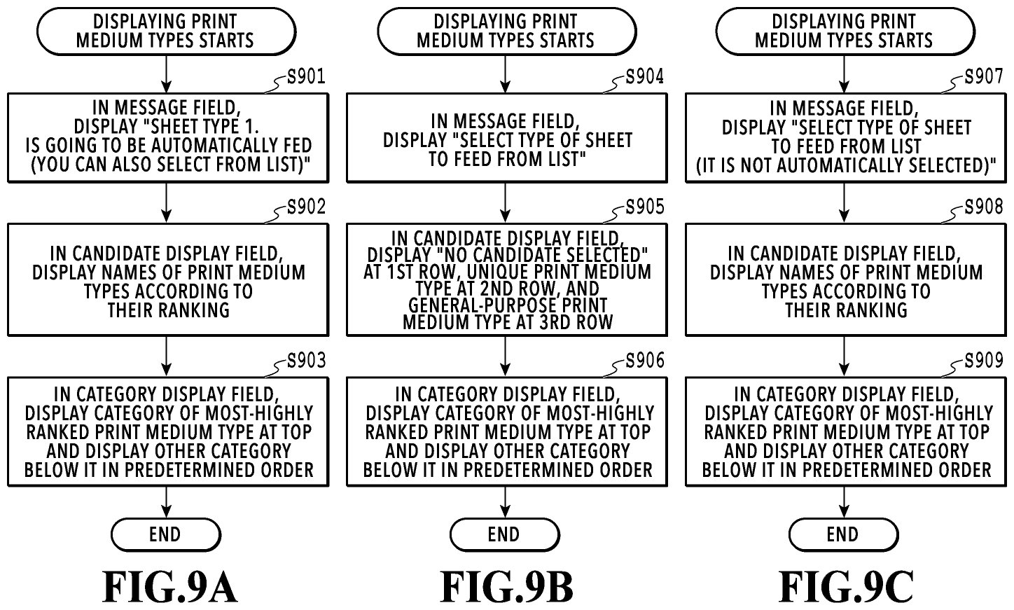

In S705, on the operation panel of the input/output unit 406, the CPU 401 displays a print settings screen including the appropriate print medium type candidates based on the order of priority determined in S704. Display methods will be described later using FIGS. 9A to 9C showing flowcharts describing what is displayed on the input/output unit 406 and FIGS. 10A to 10P showing examples of what is displayed on the input/output unit.

In S706, the CPU 401 determines whether the user operates the input/output unit 406 to select a candidate within a predetermined period of time after the print medium types are displayed. If it is determined that a select operation has been performed, the CPU 401 proceeds to S710. If it is determined that a select operation has not been performed, the CPU 401 proceeds to S707.

In S707, the CPU 401 determines that the print medium type displayed at the highest rank among the candidates on the print settings screen is the print medium type to use for printing. After completing S707, the CPU 401 ends the processing of the present flowchart.

In S708 to which the CPU 401 proceeds after determining in S703 that there is no print medium type with usage history information, the CPU 401 determines the order of priority of all the print medium type candidates extracted in S701. In this event, Formula (1) used in S704 is used similarly to rank the candidates.

In S709, on the input/output unit 406, the CPU 401 displays a print settings screen including the print medium type candidates based on the order of priority determined in S708. Display methods will be described later using FIGS. 9A to 9C showing flowcharts describing what is displayed on the input/output unit 406 and FIGS. 10A to 10P showing examples of what is displayed on the input/output unit.

In S710, the CPU 401 determines whether a print medium type is selected by the user. If it is determined that a print medium type is selected, the CPU 401 proceeds to S711. If it is determined that a print medium type is not selected, the CPU 401 stays in S710 and waits until a print medium type is selected by the user.

In S711, the CPU 401 determines that the print medium type selected by the user is the print medium type to use for printing. This means that print parameters for the print medium type determined in this step are applied to the printing of the print medium inserted to the sheet feeder. After completing S711, the CPU 401 ends the processing of the present flowchart.

### (Flowchart for Extraction of Print Medium Type Candidates)

FIG. 8 is a flowchart of extraction of print medium type candidates in the present embodiment. In other words, FIG. 8 is a diagram showing details of S701 in FIG. 7. Print medium type candidates are extracted as follows: the optical sensor 201 is used to obtain characteristic values, namely a regular reflection value, an irregular reflection value, and a paper thickness, and then the measured values thus obtained are compared with the characteristic values of each print medium type predefined and stored in the EEPROM 404.

In the flowchart in FIG. 8 in the present embodiment, print medium type candidates are extracted from the group of candidates shown in FIG. 5A.

In S801, based on results of comparing the measurement value on the paper thickness of the target print medium obtained by the optical sensor 201 with the extraction ranges for the paper thickness set for the respective print medium types stored in the EEPROM 404, the CPU 401 extracts print medium types that fall within the extraction ranges. This target print medium refers to a print medium to use for printing and a print medium inserted into the sheet feeder of the printing apparatus 100 at the start of the flowchart in FIG. 7.

In S802, the CPU 401 determines whether any print medium type has been extracted. If it is determined that print medium types have been extracted, the CPU 401 proceeds to S803. If no print medium type has been extracted, the CPU 401 proceeds to S808 and stores, in the RAM 403, information indicating that no print medium type has been extracted, and ends the print medium type candidate extraction processing.

In S803, based on results of comparing the irregular reflection value of the target print medium obtained by the optical sensor 201 with the extraction ranges for the irregular reflection values stored in the EEPROM 404, the CPU 401 extracts print medium types that fall within the extraction ranges.

In S804, the CPU 401 determines whether any print medium type has been extracted. If it is determined that print medium types have been extracted, the CPU 401 proceeds to S805. If no print medium type has been extracted, the CPU 401 proceeds to S808 and stores, in the RAM 403, information indicating that no print medium type has been extracted, and ends the print medium type candidate extraction processing.

In S805, based on results of comparing the regular reflection value of the target print medium obtained by the optical sensor 201 with the extraction ranges for the regular reflection values stored in the EEPROM 404, the CPU 401 extracts print medium types that fall within the extraction ranges.

In S806, the CPU 401 determines whether any print medium type has been extracted. If it is determined that print medium types have been extracted, the CPU 401 proceeds to S807. If no print medium type has been extracted, the CPU 401 proceeds to S808 and stores, in the RAM 403, information indicating that no print medium type has been extracted, and ends the print medium type candidate extraction processing.

In S807, the CPU 401 stores, in the RAM 403, information indicating the extracted print medium type(s), and ends the print medium type candidate extraction processing. This is the flowchart of the details of S701.

FIGS. 9A to 9C are flowcharts showing details of the processing for displaying print medium types on the input/output unit 406 in S705 and S709 in FIG. 7. FIGS. 9A to 9C show three examples of how to display the print medium types. FIG. 9A is a flowchart showing details of S705, and FIGS. 9B and 9C are each a flowchart showing details of S709.

Also, FIGS. 10A to 10P show examples of what is displayed on the input/output unit 406 corresponding to the flowcharts of display methods in FIGS. 9A to 9C. The flowcharts and display examples are merely exemplary, and content actually displayed is not limited to them. Descriptions are given below, starting from the details of S705.

FIG. 9A is a flowchart showing a display method employed in a case where at least one of the print medium type candidates extracted has usage history information. In S901, as shown in FIG. 10A, in the message field 41 on the input/output unit 406, the CPU 401 displays “Sheet type 1. is going to be automatically fed (you can also select from list).” Also, in S902, as shown in FIG. 10A, in the candidate display field 42 on the input/output unit 406, the CPU 401 displays print medium types in the order of priority of the print medium types. Further in S903, as shown in FIG. 10A, in the category display field 43 on the input/output unit 406, the CPU 401 displays the category of the most highly ranked print medium at the top, with other category displayed below according to a predetermined order. After that, the CPU 401 ends the processing of the present flowchart. Note that the steps S901 to S903 may be performed in any order or may be performed simultaneously. This is true for S904 to S906 and S907 to S909 as well.

Also, the reason why “Plain Paper” is displayed as the second category from the top in the category display field 43 in FIG. 10A is to indicate that the print medium type candidate ranked after the three types of gloss paper displayed in the candidate display field 42 is a sheet type belonging to “Plain Paper.” Thus, in an example where the category of the print medium type ranked fourth is “Film Sheet,” the category displayed at the second row from the top in the category display field 43 would be “Film Sheet.”

Next, FIG. 9B showing the print medium type candidate display processing in S709 is described. In FIG. 9B, in a case where none of the print medium type candidates extracted has usage history information, a message is displayed at the top row of the candidate display field 42 to indicate that there is no print medium type candidate. Also, one of “unique paper” types extracted is displayed at the second row, and one of “general-purpose paper” types extracted is displayed at the third row. Note that unique paper and general-purpose paper may be reversed in the order of priority.

In S904, as shown in FIG. 10C, in the message field 41 on the input/output unit 406, the CPU 401 displays “Select type of sheet to feed from list.” Also, in S905, as shown in FIG. 10C, in the candidate display field 42 on the input/output unit 406, the CPU 401 displays 1. “No candidate selected,” 2. “Premium Gloss Paper” (a candidate of unique paper), and 3. “Photo Paper (Thin)” (a candidate of general-purpose paper). Further in S906, as shown in FIG. 10C, in the category display field 43 on the input/output unit 406, the CPU 401 displays the category of the most highly ranked print medium at the top, with a category displayed below according to a predetermined order.

This is the candidate display method shown in FIG. 9B. In a case where there is no print medium type with usage history information, as an example, a candidate is extracted from each of the “unique paper” types and the “general-purpose paper” types. This is to increase the possibility where even if a user has used only unique paper or only general-purpose paper before, the candidates include one that is familiar to the user (or one that the user has used before).

Note that the category display field 43 in FIG. 10C has “No candidate selected” at the first row. The reason for this is so that the user can analogize that the print medium type is not automatically selected because the candidates being displayed have been extracted from print medium types without usage history information and may include one unintended by the user. Although any type of unique paper and any type of general-purpose paper are displayed at the second and third rows, respectively, as an example in the display method shown in FIG. 9B, it is to be noted that the present disclosure is not limited to this. In an alternative mode, among the extracted candidates, for example, a print medium type ranked high and classified into “plain paper” may be displayed at the second row, and a print medium type ranked high and classified into “gloss paper” may be displayed at the third row.

Next, a display method employed in S709 is described using the flowchart in FIG. 9C, as an example different from the flowchart in FIG. 9B. According to FIG. 9C, in S907, as shown in FIG. 10D, in the message field 41 on the input/output unit 406, the CPU 401 displays “Select type of sheet to feed from list (it is not automatically determined)” to notify that the print medium type is not automatically determined. Also, in S908, as shown in FIG. 10D, in the candidate display field 42 on the input/output unit 406, the CPU 401 displays print medium types in the order of priority of the print medium types. Further, in S909, as shown in FIG. 10D, in the category display field 43 on the input/output unit 406, the CPU 401 displays the category of the most highly ranked print medium at the top, with other category displayed below according to a predetermined order. A difference from the display method in FIG. 9B is that extracted candidates are ranked and displayed accordingly in the ranking order and then a message indicating that the print medium type is not automatically determined is displayed in the message field 41 because those candidates are without usage history information.

This is the display method in FIG. 9C. Because the display methods in FIGS. 9B and 9C showing detailed processing in S709 both display candidates without usage history information, a final decision is made by user operation. This helps prevent a mistake from being made in configuring print settings.

Note that the display methods shown in FIGS. 9B and 9C may be combined as needed. In an example alternative mode, “Select type of sheet to feed from list” is displayed in the message field 41, and “1. No candidate selected” is displayed in the candidate display field 42. Then, below that, the extracted candidates are displayed according to their ranks.

FIG. 10E shows an example of what is displayed in a case where only categories are displayed as candidates in S712 in FIG. 7 described above. Because not a single print medium type is extracted, “No candidate selected” is displayed at all of the rows in the candidate display field 42. Alternatively, based on the print history information, top ones of the categories of the print medium types printed recently in the printing apparatus 100 may be displayed in the category display field 43. Also, categories used most frequently in printing may be displayed. Also, with a certain representative print medium type being set for every category, the representative print medium types may be ranked according to how close their characteristic values are to the characteristic values obtained. Alternatively, for every print medium type belonging to each category, differences between its characteristic values and the measured values are averaged, and such average values of the print medium types are used to determine the order in which the categories are displayed based on the closeness of the characteristic values to the measured values.

As thus described, the present embodiment can improve user convenience in configuring print medium settings to apply in printing. Specifically, even in a mode where the type of the print medium fed is automatically determined, in a case where none of the candidates has usage history information, the present embodiment waits for a user to make a selection so that an unintended print medium type may not be selected. This enables improvement of user convenience in determination of a print medium type.

### Embodiment 2

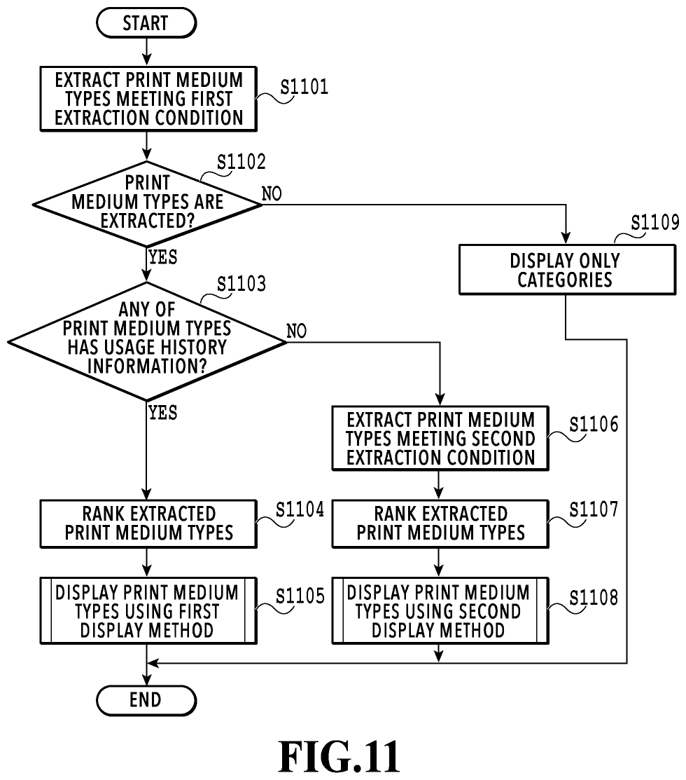

Embodiment 1 describes a configuration where even in Estimation-Based Auto Mode, in a case where none of the extracted candidates has usage history information, a print medium type is not automatically determined until a user performs a select operation. The present embodiment shows an example of what is displayed different from that in Embodiment 1 in how a notification is given to the user in a case where none of the extracted candidates has usage history information. More specifically, in a case where none of extracted the print medium type candidates has usage history information, the group of print medium type candidates is changed, and candidates are extracted anew. In the present embodiment, the group of candidates displayed in FIG. 5A is changed to one of the groups of candidates shown in FIGS. 5B to 5D. FIGS. 5B to 5D each show a group of candidates which are particular types extracted from the group of candidates in FIG. 5A. The following describes how candidates are displayed in the present embodiment with reference to FIGS. 5A to 5E and FIG. 11. Note that descriptions are omitted for processing which is similar to the processing described in FIG. 7.

### (Flow of Print Medium Type Determination)

FIG. 11 is a flowchart of print medium type determination according to the present embodiment.

In S1101, the CPU 401 extracts print medium type candidates that meet a first extraction condition. The first extraction condition is to extract candidates from the group of print medium type candidates shown in FIG. 5A (a first group of print medium type candidates) and is processing similar to S701 in Embodiment 1. A detailed description is therefore omitted.

In S1102, the CPU 401 determines whether any print medium type has been successfully extracted in S1101. If it is determined that no print medium type has been extracted, the CPU 401 proceeds to S1109. Then, in S1109, processing similar to S712 is performed, and the present flowchart ends. If it is determined that print medium types have been extracted, the CPU 401 proceeds to S1103.

In S1103, referring to the usage history information stored in the EEPROM 404, the CPU 401 determines whether any of the extracted print medium type candidates has usage history information. If it is determined that any of the print medium type candidates has usage history information, the CPU 401 proceeds to S1104 and performs processing similar to S704 and S705. If it is determined that none of the print medium type candidates has usage history information, the CPU 401 proceeds to S1106.

In S1106, the CPU 401 extracts print medium type candidates that meet a second extraction condition. The second extraction condition is to extract print medium type candidates from a second group of print medium type candidates which includes fewer print medium type candidates than the first group of print medium type candidates, using the flow in FIG. 7. For example, the second group of print medium type candidates is, as shown in FIG. 5B, a group of candidates selected from the first group of print medium type candidates as being unique paper. Alternatively, the second group of print medium type candidates is, as shown in FIG. 5C, a group of candidates selected from the first group of print medium type candidates as being general-purpose paper. Alternatively, the second group of print medium type candidates may be, as shown in 5D, a group of candidates selected to include one of print medium types from each category or may be, as shown in FIG. 5E, a group of candidates selected to include representative print medium types. Also, using FIGS. 5B and 5C, the “unique paper” candidates and the “general-purpose paper” candidates may be displayed in their respective orders of priority determined. Furthermore, the candidates may be set depending on the region for which the information processing apparatus is to be destined.

The present embodiment describes how the order of priority of “unique paper” print medium types and the order of priority of “general-purpose paper” print medium types are determined using FIGS. 5B and 5C.

In S1107, the CPU 401 ranks the print medium types extracted based on the second extraction condition. The criteria for the ranking are similar to the ones used in the method described for S704.

In S1108, the CPU 401 displays the print medium types based on the ranks determined in S1107. Because the present embodiment determines the order of priority for each of the “unique paper” print medium types and the “general-purpose paper” print medium types based on the second extraction condition using FIGS. 5B and 5C, the display method similar to that in FIG. 9B is used. Thus, content displayed on the input/output unit 406 is as shown in FIG. 10C. The “unique type” print medium type displayed at the second row (2.) of the candidate display field 42 on the input/output unit 406 is the print medium type determined in S1107 to be the highest in the order of priority among the “unique paper” print medium types. In other words, the “unique type” print medium type displayed at the second row is the candidate ranked highest among the print medium types extracted from the group of “unique paper” candidates shown in FIG. 5B. Also, the “general-purpose paper” print medium type displayed at the third row (3.) of the candidate display field 42 on the input/output unit 406 is the print medium determined in S1107 to be the highest in the order of priority among the “general-purpose paper” print medium types. In other words, the “general-purpose paper” print medium type displayed at the third row is the candidate ranked highest among the print medium types extracted from the group of “general-purpose paper” candidates shown in FIG. 5C. Note that “No candidate selected” is displayed at the first candidate row. The reason for this is so that the user can analogize that the print medium type is not automatically selected because the candidates being displayed have been extracted from print medium types without usage history information and may include one unintended by the user.

This is how candidates are displayed in the present embodiment. In a case where none of the print medium types has usage history information under the first extraction condition, as an example, a candidate is extracted from each of the “unique paper” print medium types and the “general-purpose paper” print medium types. This is to increase the possibility where even if a user has used only unique paper or only general-purpose paper, the candidates include one that is familiar to the user (or one that the user has used before).

Although the above describes a case of displaying candidates using both of FIGS. 5B and 5C as the second extraction condition, in a case where the user has used only, for example, general-purpose paper before, the second extraction condition may be defined beforehand so that candidates may be extracted from only the group of “general-purpose paper” candidates in FIG. 5C. Because candidates ultimately displayed are selected from “general-purpose paper” print medium types that are likely to be familiar to the user, it is expected that the user will be less at a loss which paper type to select. The following describes how candidates are displayed using FIG. 5C as the second extraction condition. In order to show the difference between how candidates are displayed using the display method in Embodiment 1 and how candidates are displayed using Embodiment 2, the following descriptions use examples of how candidates are ultimately displayed in the respective cases. Also, to compare Embodiment 1 and Embodiment 2, the following describes a case where none of the print medium type candidates extracted in S703 or S1103 has usage history information. Also, in the case described below, a third display method combining FIGS. 9B and 9C described above is used as the display method in each of the cases. Specifically, in the message field 41, “Select type of sheet to feed from list” is displayed, and in the candidate display field 42, 1. “No candidate selected” is shown with extracted candidates being displayed below it according to their ranks. The following description assumes that the print medium type used by the user for printing has the following measured values: regular reflection value=1000, irregular reflection value=1000, and paper thickness=280.

### (Display Example Using Embodiment 1)

As a result of extracting candidates from the group of candidates in FIG. 5A based on the measurement values in S701 in FIG. 7, “Premium Gloss Paper,” “Premium Semi-Gloss Paper,” and “Photo Paper (Thick)” are extracted. In a case where none of them has usage history information, they are ranked in the following order in S708 using Formula (1): 1. “Premium Gloss Paper,” 2. “Premium Semi-Gloss Paper,” and 3. “Photo Paper (Thick).” Using the third display method, the candidates are displayed in S709 as shown in FIG. 10F, i.e., 1. “No candidate selected,” 2. “Premium Gloss Paper,” 3. “Premium Semi-Gloss Paper.” In this case, alternatively, an indication stating that the print medium type is not automatically determined may be displayed in the message field 41, and 1. “Premium Gloss Paper,” 2. “Premium Semi-Gloss Paper,” and 3. “Photo Paper (Thick)” may be displayed in the candidate display field 42.

### (Display Example Using Embodiment 2)

In contrast to this, a description is similarly given using the flowchart in Embodiment 2. As a result of extracting candidates from the group of candidates in FIG. 5A based on the measurement values in S1101 in FIG. 11, “Premium Gloss Paper,” “Premium Semi-Gloss Paper,” and “Photo Paper (Thick)” are extracted. In a case where none of them has usage history information, candidates are extracted in S1106 using the second extraction condition. As already described, the present example assumes that the user has specified that a group of candidates including only “general-purpose paper” print medium types shown in FIG. 5C is used as the second extraction condition. Thus, “Photo Paper (Thick)” is the only candidate extracted based on the second extraction condition. Using the third display method, candidates are displayed as shown in FIG. 10G, i.e., 1. “No candidate selected,” 2. “Photo Paper (Thick),” and 3. “No candidate selected.” In this case, alternatively, an indication stating that the print medium type is not automatically determined may be displayed in the message field 41, and 1. “Photo Paper (Thick),” 2. “No candidate selected,” and 3. “No candidate selected” may be displayed in the candidate display field 42.

Comparing this outcome with Embodiment 1 shows that no “unique paper” print medium type is listed as a candidate. A user who has never used unique paper before may become at a loss in a case where candidates include unique paper. Thus, it is expected that by listing only candidates that are general-purpose paper, which is familiar to the user, the user may become less at a loss.

Also, one of FIGS. 5B to 5D may be selected by a user in advance and used as the second extraction condition. Also, based on the print medium usage by a user, the printing apparatus 100 may determine a group of print medium type candidates to use as the second extraction condition.

Print medium types may be displayed using the following display method as well.

For example, as shown in FIG. 10H, in the candidate display field 42 on the input/output unit 406, “general-purpose paper” print medium types are displayed at the first and second rows, and a “unique paper” print medium type is displayed at the third row. As shown in FIG. 10I, in the candidate display field 42 on the input/output unit 406, “No sheet type candidate” is displayed at the first row, a “general-purpose paper” candidate is displayed at the second row, and a “unique paper” candidate is displayed at the third row. Alternatively, as shown in FIG. 10J, in the candidate display field 42 on the input/output unit 406, a “general-purpose paper” candidate is displayed at the first row, and “unique paper” candidates are displayed at the second and third rows. Alternatively, as shown in FIG. 10K, in the candidate display field 42 on the input/output unit 406, “unique paper” candidates are displayed at the first and second rows, and a “general-purpose paper” candidate is displayed at the third row. FIGS. 10H to 10K are examples of how candidates are displayed in a case where, for example, the groups of candidates in FIGS. 5B and 5C are both used as the second extraction condition.

Also, FIG. 10L is an example of how candidates are displayed in a case where FIG. 5B is used as the second extraction condition, and FIG. 10M is an example of how candidates are displayed in a case where FIG. 5C is used as the second extraction condition.

Also, the order of priority in the candidate display field 42 may be determined so that a print medium type ranked lower may be determined from the same category as the print medium ranked higher. Specifically, as shown in FIG. 10N, a lower-rank candidate may be displayed from “gloss paper,” which is the category of “Premium Gloss Paper” ranked high among the candidates. As a result, candidates are displayed as follows: 1. “No candidate selected,” 2. “Premium Gloss Paper,” 3. “Premium Semi-Gloss Paper.”

Also, as shown in FIG. 10O, the input/output unit 406 may be without the candidate display field 42, and the category display field 43 may be displayed in larger size. Alternatively, as shown in FIG. 10P, the input/output unit 406 may display “No candidate selected” at the first row (1.) of the candidate display field 42, and the rest of the field may be the category display field 43. Also, fixed print medium types may be displayed in the candidate display field 42 at all times.

In this way, even in a case where none of the extracted candidates has usage history information, the present embodiment can present print medium types likely to be suitable for the user and therefore improve user convenience in print medium type determination.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-087941, filed May 30, 2024, which is hereby incorporated by reference wherein in its entirety.

What is claimed is:

1. A printing apparatus comprising:
an obtainment unit that obtains a characteristic value of a sheet inserted into a sheet feeder;
an extraction unit that extracts at least one candidate to use as a print setting for the inserted sheet from a first group of candidates of a sheet type stored in a storage unit based on results of comparison between the obtained characteristic value and each of characteristic values of the first group of candidates;
a display control unit that displays, on a display unit, a print setting screen including the extracted at least one candidate; and
a determination unit that determines a print parameter for the inserted sheet based on the extracted at least one candidate and history information indicating a history of sheet types used, wherein
in a case where the history information does not include a sheet type corresponding to the at least one candidate extracted from the first group of candidates, the determination unit determines that a candidate selected by user operation on a first print setting screen is the print parameter to use for printing, the first print setting screen being displayed on the display unit by the display control unit after the extraction unit extracts the at least one candidate, and
in a case where the history information includes the sheet type corresponding to the at least one candidate extracted from the first group of candidates, the determination unit automatically determines the print parameter for the inserted sheet even if a candidate is not selected by user operation on a second print setting screen displayed on the display unit by the display control unit after the extraction unit extracts the at least one candidate.

2. The printing apparatus according to claim 1, wherein
in a case where the history information does not include the sheet type corresponding to the at least one candidate extracted from the first group of candidates, the display control unit displays, on the display unit, the first print setting screen where the extracted at least one candidate is ranked based on a predetermined criterion, and
in a case where the history information includes the sheet type corresponding to the at least one candidate extracted from the first group of candidates, the display control unit displays, on the display unit, the second print setting screen where a candidate is ranked, the candidate being included in the extracted at least one candidate and also included in the history information.

3. The printing apparatus according to claim 2, wherein
in a case where the history information includes the sheet type corresponding to the at least one candidate extracted from the first group of candidates, the determination unit automatically determines one of the at least one candidate displayed on the display unit as the print parameter for the inserted sheet even if a candidate is not selected by user operation on the second print setting screen.

4. The printing apparatus according to claim 3, wherein
in a case where a candidate is selected by user operation on the second print setting screen within a predetermined period of time, the determination unit determines that the selected candidate is the print parameter for the inserted sheet, and
in a case where no user operation is performed on the second print setting screen within the predetermined period of time, the determination unit automatically determines one of the at least one candidate displayed on the display unit as the print parameter for the inserted sheet.

5. The printing apparatus according to claim 2, wherein
the first print setting screen includes an indication that a sheet type is not automatically determined.

6. The printing apparatus according to claim 2, wherein
an indication that there is no candidate is displayed as a highest rank on the first print setting screen.

7. The printing apparatus according to claim 1, wherein
the first group of candidates is a group of candidates including all sheet types stored in the storage unit.

8. The printing apparatus according to claim 1, wherein
the characteristic value is a value including a paper thickness, a regular reflection value, and an irregular reflection value.

9. The printing apparatus according to claim 2, wherein
the predetermined criterion defines that among the extracted at least one candidate, a candidate with a smaller absolute value of a sum of squares of differences between each characteristic value of the candidate and a corresponding measured value for the characteristic value of the sheet used for printing is ranked higher.

10. The printing apparatus according to claim 2, wherein
the predetermined criterion defines that general-purpose paper is ranked higher than unique paper in an order of priority or that unique paper is ranked higher than general-purpose paper in an order of priority.

11. The printing apparatus according to claim 1, wherein
in a case where the history information does not include the sheet type corresponding to the at least one candidate extracted from the first group of candidates, the extraction unit extracts anew at least one candidate to use as the print setting for the inserted sheet based on results of comparison between the characteristic value obtained and a second group of candidates selected from the first group of candidates based on a particular condition, and
the display control unit displays, on the display unit, a print setting screen including the at least one candidate extracted anew.

12. The printing apparatus according to claim 11, wherein
the second group of candidates is a group of candidates selected from the first group of candidates as being unique paper.

13. The printing apparatus according to claim 11, wherein
the second group of candidates is a group of candidates selected from the first group of candidates as being general-purpose paper.

14. The printing apparatus according to claim 11, wherein
the second group of candidates is a group of candidates selected from the first group of candidates to include one sheet type from each sheet category.

15. The printing apparatus according to claim 11, wherein
the second group of candidates is a group of candidates selected from the first group of candidates to include representative sheet types.

16. The printing apparatus according to claim 11, wherein
the second group of candidates is a group of candidates selected from the first group of candidates to include sheet types suitable for a region for which the printing apparatus is destined.

17. The printing apparatus according to claim 1, wherein
in a case where the history information does not include the sheet type corresponding to the at least one candidate extracted from the first group of candidates, the extraction unit extracts anew at least one candidate to use as the print setting for the inserted sheet from each of a group of candidates selected from the first group of candidates as being unique paper and a group of candidates selected from the first group of candidates as being general-purpose paper, and
the display control unit displays, on the display unit, a print setting screen including the at least one candidate extracted anew.

18. The printing apparatus according to claim 1, wherein
in a case where the extraction unit fails to extract a candidate from the first group of candidates, the display control unit displays a sheet category on the display unit as a print setting screen.

19. A method for controlling a printing apparatus, the method comprising:
obtaining a characteristic value of a sheet inserted into a sheet feeder;
extracting at least one candidate to use as a print setting for the inserted sheet from a first group of candidates of a sheet type stored in a storage unit based on results of comparison between the obtained characteristic value and each of characteristic values of the first group of candidates;
displaying, on a display unit, a print setting screen including the extracted at least one candidate; and
determining a print parameter for the inserted sheet based on the extracted at least one candidate and history information indicating a history of sheet types used, wherein
in the determining, in a case where the history information does not include a sheet type corresponding to the at least one candidate extracted from the first group of candidates, a candidate selected by user operation on a first print setting screen is determined as the print parameter to use for printing, the first print setting screen being displayed on the display unit in the displaying after the at least one candidate is extracted in the extracting, and
in the determining, in a case where the history information includes the sheet type corresponding to the at least one candidate extracted from the first group of candidates, the print parameter for the inserted sheet is automatically determined even if a candidate is not selected by user operation on the first print setting screen displayed on the display unit in the displaying after the at least one candidate is extracted in the extracting.

20. A non-transitory computer readable storage medium storing a program that functions in a printing apparatus and causes the printing apparatus to function as:
an obtainment unit that obtains a characteristic value of a sheet inserted into a sheet feeder;
an extraction unit that extracts at least one candidate to use as a print setting for the inserted sheet from a first group of candidates of a sheet type stored in a storage unit based on results of comparison between the obtained characteristic value and each of characteristic values of the first group of candidates;
a display control unit that displays, on a display unit, a print setting screen including the extracted at least one candidate; and
a determination unit that determines a print parameter for the inserted sheet based on the extracted at least one candidate and history information indicating a history of sheet types used, wherein
in a case where the history information does not include a sheet type corresponding to the at least one candidate extracted from the first group of candidates, the determination unit determines that a candidate selected by user operation on a first print setting screen is the print parameter to use for printing, the first print setting screen being displayed on the display unit by the display control unit after the extraction unit extracts the at least one candidate, and
in a case where the history information includes the sheet type corresponding to the at least one candidate extracted from the first group of candidates, the determination unit automatically determines the print parameter for the inserted sheet even if a candidate is not selected by user operation on a second print setting screen displayed on the display unit by the display control unit after the extraction unit extracts the at least one candidate.
